(19) United States
(12) Patent Application Publication
(10) Pub. No.: US 2023/0390688 A1
(43) Pub. Date: Dec. 7, 2023

(54) WASHABLE FINE DUST FILTER MODULE USING NANO FIBER

(71) Applicant: HANSAE CO., LTD., Incheon (KR)

(72) Inventors: Se Gil SONG, Seoul (KR); Sung Wook YANG, Incheon (KR)

(21) Appl. No.: 18/032,296

(22) PCT Filed: Jul. 9, 2021
(86) PCT No.: PCT/KR2021/008832

§ 371 Date: Apr. 17, 2023

(30) Foreign Application Priority Data
Dec. 28, 2020 (KR) 10-2020-0184105

(51) Int. Cl. B01D 46/52; B01D 46/00; B01D 39/16

(52) U.S. Cl. CPC B01D 46/523; B01D 46/0002; B01D 39/1623; B01D 46/0032; B01D 2239/025; B01D 2239/0631; B01D 2239/065

(57) ABSTRACT

The present invention relates to a washable fine dust filter module using nano fibers, the filter module comprising: a filter member (10) having a multi-layered structure that includes a nano fiber layer using nano fibers and is corrugated at regular intervals; and a water-repellent treated filter frame (20) for accommodating the filter member (10). The filter module manufactured using the nano fibers according to the present invention can remove fine dust in the nano fiber layer and an MB filter layer, and thus increase filter efficiency. Also, the filter frame is treated so as to be water repellent, and a hot melt coating layer is applied to only a portion of the thickness of the upper and lower sections of the filter member, such that a user can use the filter module by freely and repeatedly washing the filter module with water (a washable function is imparted). In addition, filter performance can be effectively maintained even after the filter module is washed with water, and thus the present invention has the effect of enabling repetitive washing and regeneration.

### TECHNICAL FIELD

The teachings in accordance with exemplary and non-limiting embodiments of this invention generally relate to a washable fine dust filter module using nano fiber, and more particularly to a washable fine dust filter module using nano fiber configured to effectively remove fine dust using nano fiber that is reusable by washing several times.

### BACKGROUND ART OF THE INVENTION

The ever worsening air pollution, yellow dust, fine dust, and ultrafine dust have seriously contaminated indoor and outdoor airs, and as a result, the use of air purifiers that can purify thus polluted airs and remove fine dust or ultrafine dust is now essential in homes and offices.

The fine dust filters currently used in air purifiers mostly have used electrostatic filters manufactured in MB (Melt blown) method. The melt blowing method is manufactured by adding electrostatic charge or fiberizing a polymer film to which electrostatic charge is added when manufacturing a nonwoven fiber, and a collection mechanism by electrostatic force is added in addition to the collection mechanisms of a nonwoven air filter to greatly improve filtration efficiency. Therefore, it has been the most preferred method so far because of its good initial filtration performance.

However, as a result of measuring the change in efficiency by operating the actual air purifier at the rated air volume, it was found that the efficiency fell sharply to 60% in two and a half months (75 days). This means that when an air purifier is purchased and used according to the size of a 20-pyeong house, it initially produces clean efficiency suitable for 20-pyeong, but its performance decreases to about 12 pyeong (1 pyeong=0.11 sq. yds) after about three months of use. In other words, indoor fine dust cannot be effectively removed.

Furthermore, these electrostatic filters cannot be regenerated because fine dust is embedded inside the filter, so there is a problem that they must be replaced periodically, which is expensive to maintain and requires regular management.

In order to solve the said problem, a nano membrane-type filter was used, which has a problem of high pressure loss to produce high efficiency by cleaning through surface filtration. In other words, when mounted on a 20-pyeong air purifier, there is a problem that performance is greatly reduced to the initial early 10-pyeong range.

Recently, technologies that add various types of nano fibers have been proposed to solve the problems of air purifier filters using these conventional methods. When these nanofibers are used in a filter, the specific surface area is very high compared to the existing filter, the surface functional group has good flexibility, and the nano-level pore size makes it possible to filter fine dust particles more efficiently. In particular, fine dust particles had to be removed using static electricity due to pore size problems in existing filters, but they can be efficiently removed in filters using nano fibers with nano-sized pores.

Looking at the prior art for this, Korea Registered Patent 10-2129418 disclosed a fine dust blocking filter in the air equipped with nano fibers including a structure sequentially stacked with a mesh substrate, a nano fiber layer, and a protective mesh, wherein the nano fiber layer is formed of a core sheath-type fiber composite spinning of a polymer resin/adhesive, and the mesh substrate is composed of filament with a diameter of 0.1˜0.8 mm, has an eye size of 2˜30 mesh, the polymer resin is at least one selected from the group consisting of polyvinylidene fluoride (PVDF), polyamide, polyester, and polyurethane, and, the adhesive is a mixed solution obtained by dissolving a polyurethane component in 1 methyl-2-pyrrolidone (1-methyl-2-pyrrolidone (NMP).

However, from the said patent, in view of the fact that there is little difference in air permeability and dust collection efficiency before and after washing in the case of a blocking filter that forms a nano fiber layer by core sheath-type fiber composite radiation of polymer resin/adhesive, although there is an effect that the composite spun nano fibers cannot be detached even under severe external environmental change conditions, there is no way of confirming whether the protective mesh used for the outermost layer, as a commercial PET honeycomb net mesh, can be used even after several water washing.

Furthermore, Korea Laid-open Patent 2015-0092060A disclosed a filter containing polyvinylidene fluoride nano fibers, comprising: cellulose substrate; and polyvinylidene fluoride nano fiber nonwoven fabric formed by electrospinning a polyvinylidene fluoride solution on the cellulose substrate, wherein the cellulose substrate and the polyvinylidene fluoride nano fiber nonwoven fabric are thermally fused, and wherein the polyvinylidene fluoride nano fiber nonwoven fabric includes: a first polyvinylidene fluoride nanofiber nonwoven fabric layer with a fiber diameter of 150˜300 nm; and a second polyvinylidene fluoride nano fiber nonwoven fabric layer having a fiber diameter of 100˜150 nm formed by electrospinning on the first polyvinylidene fluoride nano fiber nonwoven fabric layer, and wherein the 0.35D DOP % efficiency calculated by the following formula (1) is 90˜93% or more, and the pressure drop measured by ASHRAE 52.1 according to the flow rate of 50 μg/m3 is 4.2˜4.5 in·w·g.

However, there may be a problem in the above patent in that pressure loss cannot be maintained due to use of a polyvinylidene fluoride nano fiber with a diameter of 100˜300 nm, which is not desirable.

### DETAILED DESCRIPTION OF THE INVENTION

### Technical Subject

Accordingly, it is an object of the present invention to provide a fine dust filter module using nano fibers that can not only wash and regenerate many filters but also remove more than 75% of fine dust by solving low usability and non-renewable problems of existing MB filters, high differential pressure problems of nano fibers, and inability to clean and regenerate filters.

### Technical Solution

In one general aspect of the present invention, there may be provided a cleanable fine dust filter module using nano fibers, comprising: a filter member 10 having a multi-layered structure including a nano fiber layer using nano fibers where the multi-layered structure has a wrinkled shape spaced apart at regular intervals; and a water-repellent filter frame 20 that accommodates the filter member 10.

According to an exemplary embodiment of the present invention, the nano fiber may be any one selected from: what was manufactured by electrospinning using polyvinylidene fluoride (PVDF) with an efficiency of 75˜95% and a pressure loss of less than 10 mmAq, or by using thermoplastic polyurethane (TPU); and PTFE manufactured using an elongation method with an efficiency of 70˜95% and a pressure loss of less than 5 mmAq.

The multilayer structure forming the nano fiber layer may preferably be any one selected from: a melt blown (MB) electrostatic filter layer/PET support layer/nano fiber layer, PET support layer/MB electrostatic filter layer/nano fiber layer, MB electrostatic filter layer/PET support layer/first nano fiber layer/second nano fiber layer; and an MB electrostatic filter layer/nano fiber layer/PET support layer MB.

According to an exemplary embodiment of the present invention, the filter member 10 may preferably include a hot-melt coating layer 11 formed on the upper and lower parts of the filter member 10 for fixing a pitch gap of the filter module with a gap of 40˜70 mm and a thickness of 1˜5 mm in order to maintain a corrugated shape spaced apart from each other at regular intervals.

According to an exemplary embodiment of the present invention, removal of fine dust using the fine dust filter may preferably implemented through: a primary surface filtration process in which 80±10% of fine dust is removed when passing through the nano fiber layer; and a secondary depth filtration process in which the remaining 20±10% of fine dust that cannot be removed from the nano fiber layer and that passes through the nano fiber layer is removed while passing through the MB electrostatic filter layer.

According to an exemplary embodiment of the present invention, the fine dust filter is used to remove fine dust (particular matter, PM-10) less than 1 OM, and the filter efficiency for the fine dust is 95% or more at a wind volume of 1˜10 CMM.

According to an exemplary embodiment of the present invention, the filter module is water washable, and the filter efficiency for fine dust after water washing is characterized by more than 95% at the air volume of 5 CMM.

### Advantageous Effects

The filter module manufactured by using a nano fiber can increase the filter efficiency by dually removing the fine dust through a nano fiber layer and MB electrostatic filter layer, whereby a user can freely water-wash repeatedly by providing a water-repellent process of filter frame and providing a hot-melt coating layer only on thickness of upper and lower parts of the filter member (washable function provided).

### BRIEF DESCRIPTION OF DRAWINGS

FIG. 1 illustrates a structure of fine dust filter module using a nano fiber according to an exemplary embodiment of the present invention,

FIG. 2 illustrates a schematic view and a photograph in which the hotmelt coating layer 11 is formed on an upper part of filter member 10 according to an exemplary embodiment of the present invention,

FIG. 3 illustrates a photograph in which the conventional hotmelt coating layer is coated on an entire surface of filter member,

FIG. 4 illustrates an example of a photograph of filter member 10 having a multi-layered structure according to an exemplary embodiment of the present invention,

FIGS. 5 to 14 illustrate measured results in which performances of each filter manufactured by exemplary embodiments of 1-7, and comparative examples of 1-3 were measured,

FIG. 15 illustrates a water-repellent performance of filter frame measured in response to comparative example 4 and second exemplary embodiment, and

FIG. 16˜22 illustrate filter performances measured while each filter module manufactured in response to exemplary embodiments 1-6 and comparative example 2 was washed three times.

### SUMMARY OF THE INVENTION

The present invention will be described hereinafter in detail in the following manner.

The terminology used herein is for the purpose of describing particular exemplary embodiments only and is not intended to be limiting. As used herein, the singular forms “a”, “an” and “the” may be intended to include the plural forms as well, unless the context clearly indicates otherwise. The terms “comprises,” and/or “comprising,” are inclusive and therefore specify the presence of stated features, integers, steps, operations, elements, and/or components, but do not preclude the presence or addition of one or more other features, integers, steps, operations, elements, components, and/or groups thereof.

The present invention relates to a fine dust filter module using nano fibers.

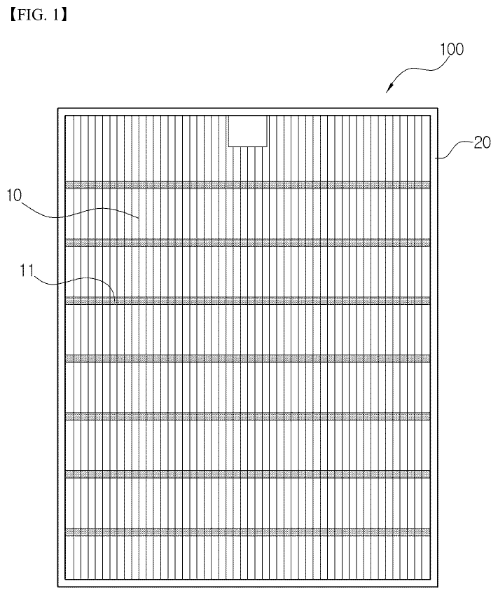

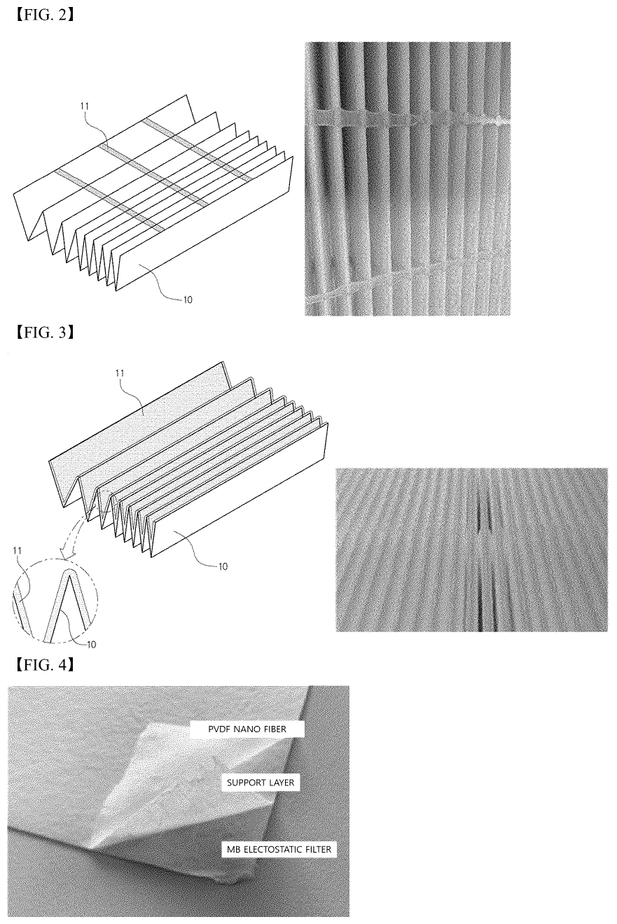

The fine dust filter module 100 using nano fibers according to an exemplary embodiment of the present invention may be formed with a filter member 10 and a filter frame 20 by referring to FIG. 1.

The filter member 10 may be of a multi-layered structure including a nano fiber layer, and the multi-layered filter member may have a wrinkled shape spaced apart at regular intervals. Furthermore, the filter frame may accommodate the filter member 10 and may be characterized by being water-repellent processed to repel water at its outside.

According to an exemplary embodiment of the present invention, the ‘multi-layered structure’ in the multi-layered filter member 10 including a nano fiber layer using the nano fiber may have any one structure selected from a melt blown (MB) electrostatic filter layer/PET support layer/nano fiber layer, PET support layer/MB electrostatic filter layer/nano fiber layer, MB electrostatic filter layer/PET support layer/first nano fiber layer/second nano fiber layer; and an MB electrostatic filter layer/nano fiber layer/PET support layer MB.

The filter member 10 according to an exemplary embodiment of the present invention may include a nano fiber layer using a nano fiber, wherein the nano fiber preferably use: what was manufactured by electrospinning using polyvinylidene fluoride (PVDF) with an efficiency of more than 75%, preferably 80˜95% and a pressure loss of less than 10 mmAq, preferably 1-6 mmAq or by using thermoplastic polyurethane (TPU); and PTFE manufactured using an elongation method with an efficiency of 70˜95% and a pressure loss of less than 5 mmAq, preferably 1˜4 mmAq.

Particularly, the nano fiber according to the present invention may not be greatly restricted in a diameter of nano fiber (nano fiber diameter) when the abovementioned efficiency and pressure loss are satisfied, but it is preferable that the nano fiber diameter be minimally maintained in order to maintain the abovementioned said efficiency and pressure loss.

When the PVDF is used as nano fiber forming the nano fiber layer according to the present invention, the nano fiber diameter may be less than 200 nm, preferably 60 nm˜100 nm. When the PVDF fiber diameter is less than 60 nm or more than 100 nm, it is not preferable because a low differential pressure surface filtration membrane effect with good pressure loss cannot be obtained.

However, when the nano fiber layer is formed with a multi-layered structure of two or more layers, it is preferable that PVDFs as nano fibers having different fiber diameters be used. For example, a first nano fiber layer may be formed by using PVDF having a fiber diameter of 60 nm˜100 nm, and the second nano fiber layer may be formed by using PVDF of 300 nm˜500 nm. At this time, what is preferably important is that the nano fiber layer located at the outside with a relatively large fiber diameter can protect other inside nano fiber layers, whereby air permeability can be maintained.

The nano fiber layer, as fabric itself, according to the present invention is characterized by the function of surface filtration that removes about 80±10% of fine dust when passing through the nano fiber layer from the surface where fine dust enters by having a certain efficiency and pressure loss value.

Furthermore, the remaining fine dust that has passed through the nanofiber layer without being removed from the nanofiber layer serves as a depth filtration that removes 20±10% of fine dust secondarily while passing through the MB electrostatic filter layer. In addition, it is a strategy to minimize the load at the MB electrostatic filter layer. However, when the efficiency of each nano fiber constituting the nanofiber layer is too high beyond the above range, pressure loss may increase, which is not preferable.

In this case, by performing 100% filtering on the MB electrostatic filter layer, as in the conventional manner, the load on the MB electrostatic filter layer can be effectively reduced, extending the life of the MB electrostatic filter, and maximizing fine dust removal efficiency through secondary filtration processes of surface filtration and depth filtration.

In the said multi-layered structure, the PET support layer can maintain a wrinkled shape well when the filter member is used as a filter by being made in a wrinkled shape spaced apart from each other at regular intervals to thereby allow wind to pass well.

It is preferable that PET fibers used as the said PET support layers have a weight of 60 to 110 g/m², a thickness of 0.2 to 0.5 mm, a tensile strength of 5 to 15 Kg in the direction of the machine (MD), a tensile elongation of 20 to 40% in the direction of the machine (MD), and an air permeability of 300 to 550 cm²/sec. Furthermore, in order to improve a support effect, 0.1 to 10 parts by weight of glass fiber may be added to the PET support layer based on 100 parts by weight of the PET fiber.

Furthermore, in the multi-layer structure forming the filter member according to the present invention, the MB electrostatic filter layer is an electrostatic filter that is in charge of filtering from a normal filter, and in the present invention, 80±10% of fine dust is primarily removed from the nano fiber layer, and the remaining fine dust passing through the nano fiber layer is effectively removed using electrostatic force.

The MB electrostatic filter layer according to the present invention may be manufactured with a thickness of about 0.1 to 0.5 mm using PP fibers with a fiber thickness of 0.5 to 3.5 cm², and the MB layer is preferable to remove fine dust with an average pore size of 8˜15 μm, air permeability of 15˜50 cm²/cm²/s, a flat weight of 10˜40 gsm, and a differential pressure of 5˜50 Pa.

When the multi-layered structure of the filter member 10 according to the present invention is formed with an MB electrostatic filter layer/PET support layer/nano fiber layer, a hot melt adhesive may be preferably used for adhesion to the remaining MB electrostatic filter layer, after the nano fiber layer and the PET support layer are adhered through thermal adhesion, a hot melt adhesive may be preferably used for adhesion to the remaining MB electrostatic filter layer.

Meanwhile, in order to maintain the wrinkled shape at regular intervals, it is preferable to include the hot-melt coating layer 11 at 1˜5 mm thickness on the upper and lower parts, not the entire wrinkle, at regular intervals of about 40˜70 mm along the wrinkle direction of the multi-layered filter member for fixing the pitch spacing of the filter module. The hot-melt used in the hot-melt coating layer 11 may be any one of the known ones including polyurethane, polyvinyl alcohol, and polyolefin.

Generally, when a filter member is manufactured in a wrinkled shape at regular intervals, if the filter member is lengthened, the PET support layer cannot be maintained of its shape and is bent unless the PET support layer is completely thick. Therefore, in order to prevent the bending of such filter members, it has played a role in fixing the entire wrinkled form by a method such as hot-melt coating.

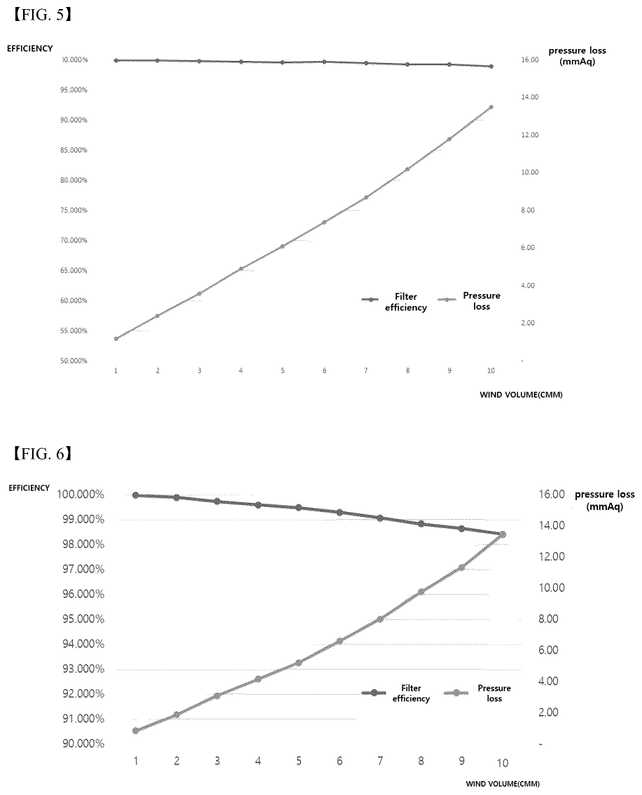

However, when the hot-melt coating is conventionally performed on the entire wrinkle shape as shown in FIG. 3, the hot-melt coating layer may be dusty and thus may not be smoothly washed, and therefore, a problem arises that the washable filter purported by the present invention may not be manufactured.

In case of the present invention, only the upper and lower parts of the filter members 10 having the multi-layered structure are coated with only a constant thickness of 1˜5 mm at regular intervals, whereby the dust attached to the filter member 10 can be washed along with water to be effectively removed, while the wrinkle shape is well maintained without bending, thereby increasing filter efficiency, and an effect of reducing cost and process time can be accomplished by performing hot-melt coating only on upper and lower parts, as compared to the conventional case.

When the thickness of the coating on the filter member is less than 1 mm, the filter may be bent and thus may not maintain a wrinkle shape, which is not preferable, and furthermore, if the coating thickness exceeds 5 mm, it may interfere with the filtration area of the filter and increase pressure loss, and it is not preferable because there is a problem that the thickness may increase and may greatly affect the specification of the filter.

The filter module according to the present invention may be manufactured by manufacturing the filter member 10 having the above multi-layered structure in a wrinkled shape at regular intervals and then receiving the same in the filter frame 20.

The filter frame 20 may be used in accordance with the size of the filter member 10 by compressing the PET nonwoven fabric, and the material of the filter frame 20 is not particularly limited.

Particularly, in this invention, it is preferable to prevent the MB electrostatic filter layer from getting wet during water washing by water-repellent coating the four sides of the filter frame 20. Even if the MB electrostatic filter layer is disposed inside and the PP resin that makes up the same is hydrophobic, it is electrostatic and can be wet through repeated water washing, and in this case, not only the drying time is separately required, but there is a problem that the filter efficiency is degraded, which is not preferable.

It is desirable to use a polyolefin-based water repellent for the water repellent processing of the filter frame, but it is not particularly limited as long as it is a water repellent that prevents the same from getting wet during repeated water washing.

As in the present invention, a filter using nano fibers may be effectively used to remove fine dust (particular matter, PM-10) of less than 10 μm, and the filter efficiency of the fine dust has, at a wind volume of 10 cmm, 95% or more, preferably 98˜99%, and has a low pressure loss value in the same module standard to characteristically provide a high circulation rate.

Furthermore, the filter module using the nano filters according to the present invention can be washed 1˜10 times, the filter efficiency for fine dust after the said water washing is 90% or more, and preferably, the filter efficiency for fine dust after three times of water washing is characteristically 95% or more.

Therefore, the filter module manufactured according to the present invention can increase the filter efficiency by dually removing fine dust from the nano fiber layer and the MB electrostatic filter layer, the hot-melt coating layer is applied only to the water repellent treatment of the filter frame and some thicknesses of the upper and lower parts of the filter member, thereby allowing a user to perform and use water washing repeatedly (providing washable function), whereby the filter module has an effect of maintaining an effective filter performance even after water washing.

### BEST MODE

Hereinafter, exemplary embodiments according to the present invention will be described in detail. The following embodiments are for illustrative purposes only, and the scope of the present invention should not be interpreted as being limited by these embodiments. In addition, although a specific compound was used for exemplification in the following embodiment, it should be obvious to those skilled in the art that the use of these equivalents can have an equally similar effect.

### First to Sixth Exemplary Embodiments, First to Third Comparative Examples: Filter Module Manufacturing

1) Manufacturing of Filter Member of Multi-Layered Structure

A PET support layer with an air permeability of 420 cm²/cm²/sec, an MD tensile strength of 12 kg, and an MD tensile elongation of 30% was manufactured using a low melting point binder fiber (LM-PET) with a weight of 70 g/m² and a thickness of 0.4 mm.

The MB electrostatic filter layer used PP nonwoven fabrics manufactured with an average pore size of 10 μm, air permeability of 30 cm²/cm²/s, flat weight of 110 gsm, differential pressure of 28 Pa, and electrostatic thickness of about 0.5 mm with a filter efficiency of 99.980%, using PP fiber with fiber thickness of 0.5 μm.

The nanofiber layer was manufactured by electrospinning TPU nano fibers and PVDF nano fibers, respectively; and PTFE nano fibers were used by manufacturing in a stretching method, and the detailed content thereof was given and used by the following Table 1.

TABLE 1

| | Nano fiber layer ⁽¹⁾ | | Filter module | | | |
|---|---|---|---|---|---|---|
| | Differential | | Hot-melt coating layer | | | Number of |
| | pressure | Efficiency | Coating gap | Coating | Module | wrinkles |
| | (mmAq) | (%) | (mm) | thickness(mm) | specification | (mountains) |
| First exemplary | 4.3 | 81.8 | 53 | 2.3 | 300*400*30T | 74 |
| embodiment | | | | | | |
| second exemplary | 3.7 | 91.9 | 53 | 3.2 | 300*400*30T | 74 |
| embodiment | | | | | | |
| third exemplary | 2.8 | 82.4 | 70 | 2.5 | 300*400*30T | 37 |
| embodiment | | | | | | |
| Fourth exemplary | 3.9 | 86.8 | 53 | 3.5 | 265*385*25T | 53 |
| embodiment | | | | | | |
| Fifth exemplary | 5.3 | 87.7 | 70 | 1.7 | 300*400*30T | 74 |
| embodiment | | | | | | |
| sixth exemplary | 5.7 | 90.3 | 60 | 2.9 | 300*400*30T | 37 |
| embodiment | | | | | | |
| seventh exemplary | 4.0 | 75.2 | 70 | 2.5 | 265*385*25T | 53 |
| embodiment | | | | | | |
| First comparative | 18 | 86 | 53 | 3.2 | 300*400*30T | 74 |
| example | | | | | | |
| second comparative | 12 | 85 | 50 | 2.4 | 300*400*30T | 37 |
| example | | | | | | |
| third comparative | 5.3 | 68 | 60 | 2.9 | 300*400*30T | 74 |
| example | | | | | | |

⁽¹⁾ First exemplary embodiment: Electrospun TPU nano fibers with a fiber diameter of 60 nm
Second ~ fourth exemplary embodiments: Electrospun PVDF nano fibers with fiber diameters of 63, 74, and 80 nm
Fifth ~ seventh exemplary embodiments: Stretched PTFE nano fibers
First comparative example: Electrospun TPU nanofibers with a fiber diameter of 50 nm
Second comparative example: Electrospun PVDF nano fibers with fiber diameter of 110 nm
Third comparative example: Stretched PTFE nano fiber

The filter members were prepared (manufactured) based on each exemplary embodiment and comparative example that is of sequentially stacked structure with MB electrostatic filter layer, PET support layer, and nanofiber layer by adhering the thus-manufactured PET support layers, MB electrostatic filter layer, and nano fiber layer respectively. The MB electrostatic filter layer and the PET support layer were adhered using a polyolefin-based hot-melt adhesive, and were adhered to the nano fiber layer by thermal adhesion, thereby preparing a filter member having the structure shown in FIG. 4.

2) Wrinkle Formation and Hot Melt Layer Formation

Each of the prepared filter members was folded at regular intervals to form a wrinkled shape, and the wrinkled gap (spacing) of each embodiment is shown as in Table 1. Furthermore, in the wrinkled filter member of each embodiment, a hot melt coating layer was formed by spray coating the same on top and bottom of the filter member at the thickness and interval as shown in Table 1 along a direction in which the wrinkles were formed by using a polyolefin-based hot melt.

3) Filter Frame Water Repellent Coating and Filter Module Manufacturing

A filter frame for accommodating the filter member was prepared according to the size of Table 1 by compressing a PET nonwoven fabric. The prepared filter frame was coated with a polyolefin-based water repellent by dipping processing and then water repellent-treated.

Finally, the final filter module was completed by receiving the filter member prepared in the above 2) from the water repellent-treated filter frame.

### Fourth Comparative Example: Non Water Repellent-Treated Filter Module Manufacturing

In the second exemplary embodiment, a filter module that has not undergone a process of performing a water repellent coating of the filter frame in step 3) was compared with the present invention.

### Fifth Comparative Example: Manufacturing of Filter Module Coated with Hot Melt on Entire Filter Member

Except for coating of hot melt layer by 3.5 mm across the entire filter member formed with wrinkles of the said 2) step, it was manufactured and compared in the same method as that of the filter module in accordance with the four exemplary embodiment.

### First Experimental Example: Filter Performance Evaluation

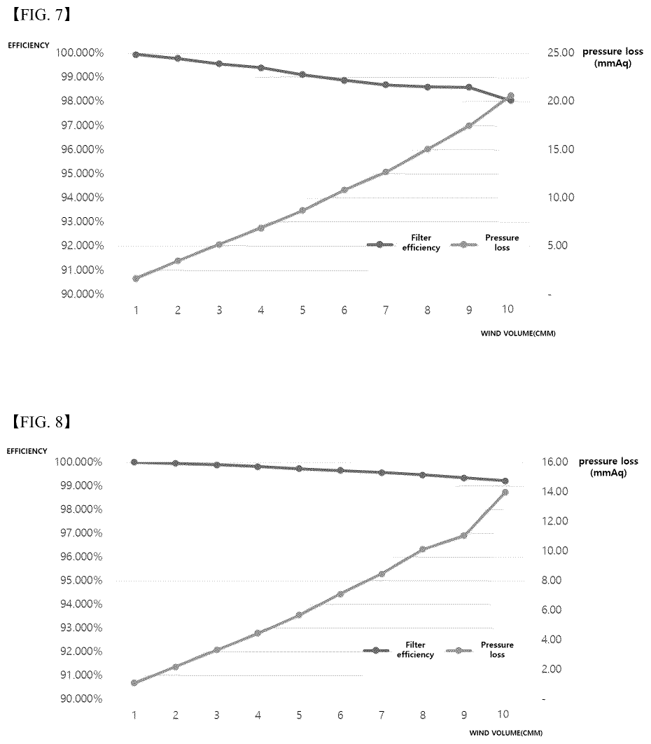

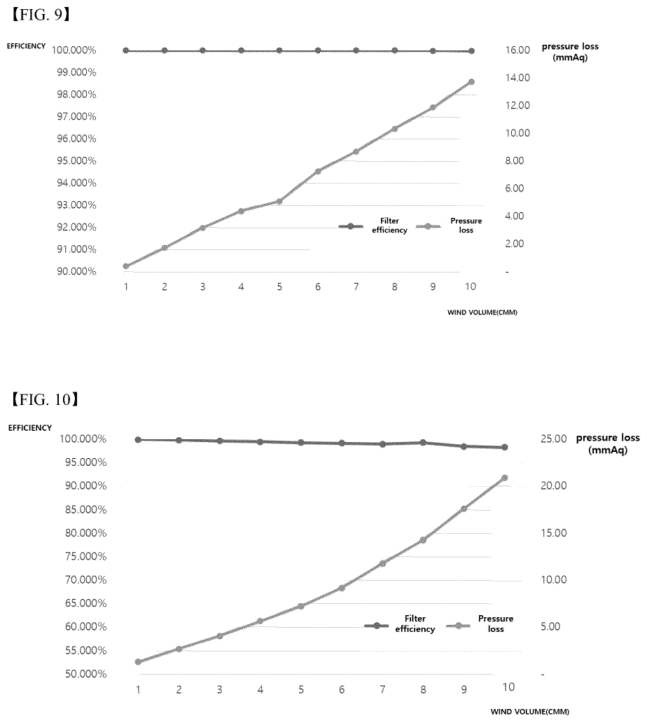

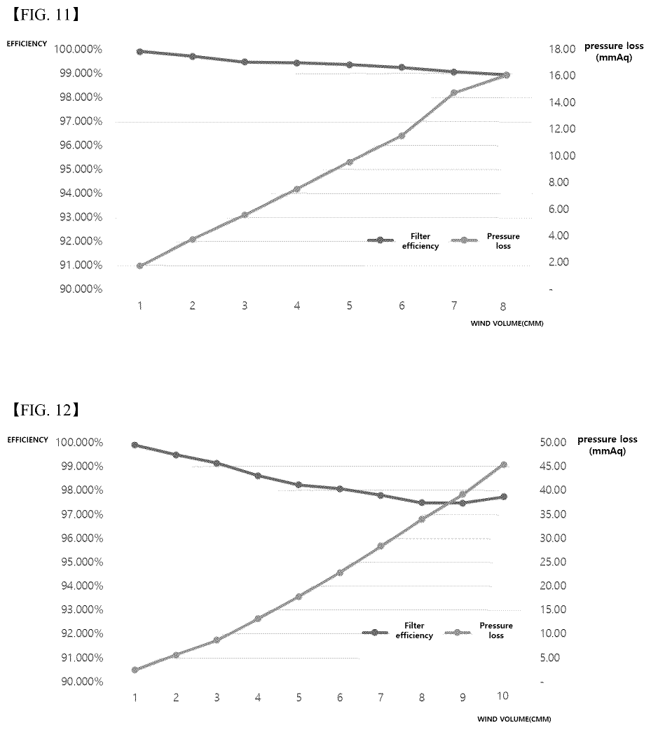

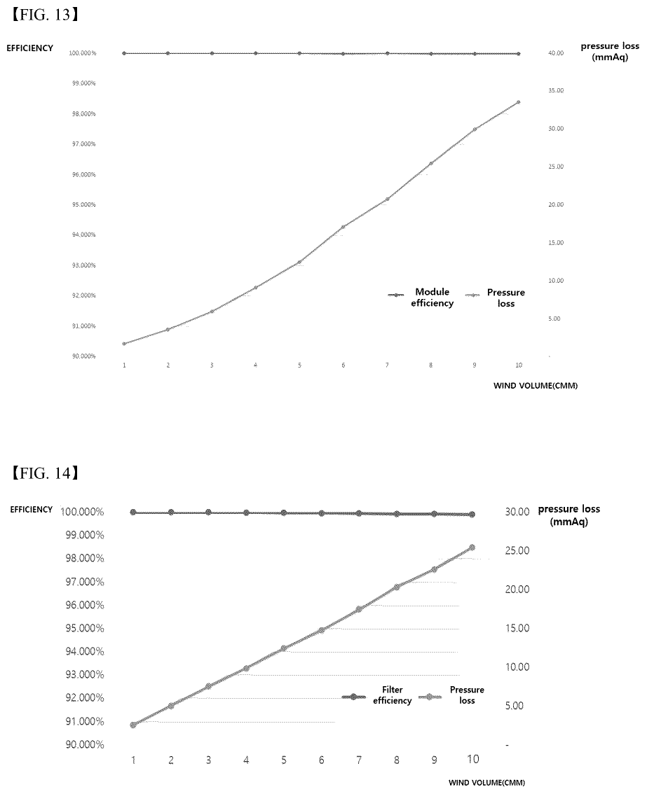

The efficiency for each wind volume and pressure loss changes of each filter prepared according to first to seventh exemplary embodiments and first to third comparative examples were measured in the wind turbine according to the KS B 6141 method, and the results thereof are shown in the following Table 2 and FIGS. 5 to 14.

TABLE 2

| | | | | | Filter | |
|---|---|---|---|---|---|---|
| | | | | | performance | |
| | | | | | (wind volume | |
| | Nano fiber layer | | Filter module | | 10CMM condition) | |
| | Differential | | | Number of | | Differential |
| | pressure | efficiency | Module | wrinkles | Efficiency | pressure |
| | (mmAq) | (%) | specification | (mountain) | (%) | (mmAq) |
| First exemplary | 14.3 | 81.8 | 300*400*30T | 74 | 99.9 | 13.0 |
| embodiment | | | | | | |
| second exemplary | 3.7 | 91.9 | 300*400*30T | 74 | 98.5 | 13.1 |
| embodiment | | | | | | |
| third exemplary | 2.8 | 82.4 | 300*400*30T | 37 | 98.0 | 20.5 |
| embodiment | | | | | | |
| Fourth exemplary | 3.9 | 86.8 | 265*385*25T | 53 | 99.2 | 13.8 |
| embodiment | | | | | | |
| Fifth exemplary | 5.3 | 87.7 | 300*400*30T | 74 | 99.0 | 15.9 |
| embodiment | | | | | | |
| Sixth exemplary | 5.7 | 90.3 | 300*400*30T | 37 | 98.0 | 21.0 |
| embodiment | | | | | | |
| Seventh exemplary | 4.0 | 75.2 | 265*385*25T | 53 | 99.8 | 19.2 |
| embodiment | | | | | | |
| First comparative | 18 | 86 | 300*400*30T | 74 | 97.9 | 45.0 |
| example | | | | | | |
| Second | 12 | 85 | 300*400*30T | 37 | 99.9 | 33.5 |
| comparative | | | | | | |
| example | | | | | | |
| Third comparative | 5.3 | 68 | 300*400*30T | 74 | 99.8 | 25.4 |
| example | | | | | | |

Referring to the results of Table 2 and FIGS. 5 to 14, it may be confirmed that the filter according to the first exemplary embodiment using the TPU nano fiber shows an excellent filter performance and pressure loss values. However, even if TPU nano fibers with a fiber diameter smaller by 50 nm than that of the first exemplary embodiment were electrospun, the filter of the first comparative example having a high differential pressure of the nano fiber layer had excellent efficiency but a problem of very high pressure loss (differential pressure).

Furthermore, in the case of the filter using PVDF nano fibers, the second to fourth exemplary embodiments with a nano fiber particle diameter of 100 nm or less show that, based on the same module size, it can be verified that the filter performance is 98% or more and the pressure loss (differential pressure) value is 22 or less under the air volume 10 CMM condition.

However, In the case of comparative example 2 in which the nano fiber particle diameter exceeds 100 nm even when PVDF nano fibers are used, based on the same module size, the filter performance maintains a value of 95% or more under the air volume 10 CMM condition, but it was confirmed that the differential pressure value exceeds 30.

Furthermore, in the case of filters according to the fifth to seventh exemplary embodiments using a nano fiber layer prepared by stretching PTFE nanofibers, it can be also confirmed of an excellent effect that the filter performance is 98% or more under the wind volume condition, and the pressure loss (differential pressure) value is also 22 or less.

However, even in the identically manufactured PTFE nano fiber layer, and in the case of the third comparative example with less than 70% efficiency, it was confirmed that the pressure loss value is 25.4, which is somewhat higher than that in the fifth exemplary embodiment.

Normally, as the air volume value increases, the differential pressure value increases, but as in first to third comparative Examples, a steep increase in the pressure loss (differential pressure) value is not preferable due to a problem in that the circulation rate of the wind is degraded and the use of the filter module in a desired part is limited.

### Second Experimental Example: Measurement of Water Repellent Performance for Filter Frame

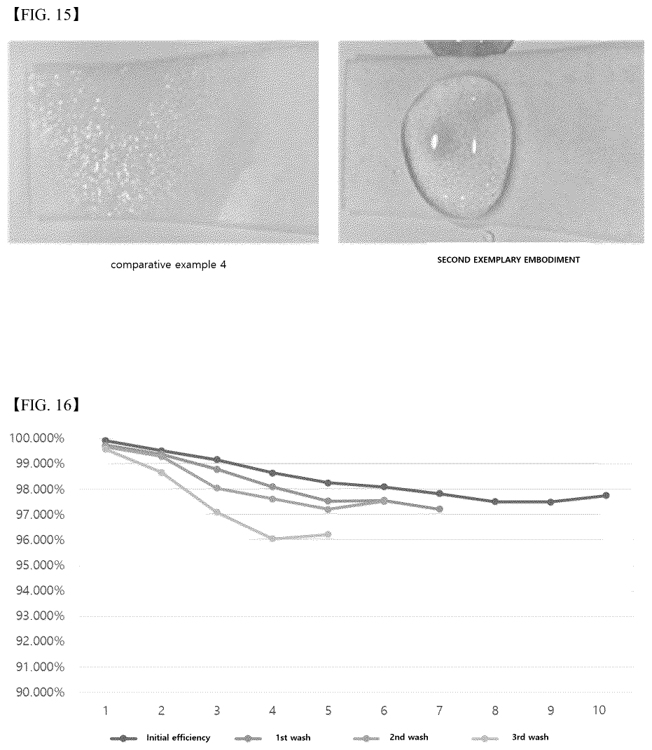

In order to confirm the water repellent-treated effect of filter frame according to the present invention, the water repellent performance of the filter frame treated according to the second exemplary embodiment and the filter frame that was not water repellent as in comparative example 4 were measured in terms of water repellency by allowing flowing down the water at a inclination according to KS M 7057, and the water repellency was R8 or more, and the results thereof were shown in the following FIG. 15.

Referring to the result of the following FIG. 15, in the case of filter frame according to the fourth comparative example (left), it can be confirmed that the surface is all soaked, whereas, in the case of the filter frame according to the second exemplary embodiment (right) which is water repellent as in the present invention, it can be confirmed that water droplets flow down from the surface as they are.

From these results, it was confirmed that by adding a water repellent function to the filter frame according to the invention, it was possible to prevent the internal MB electrostatic filter layer from being wet even during repeated water washing.

### Third Experimental Example: Measurement of Efficiency for Each Wind Volume Based on Water Washing

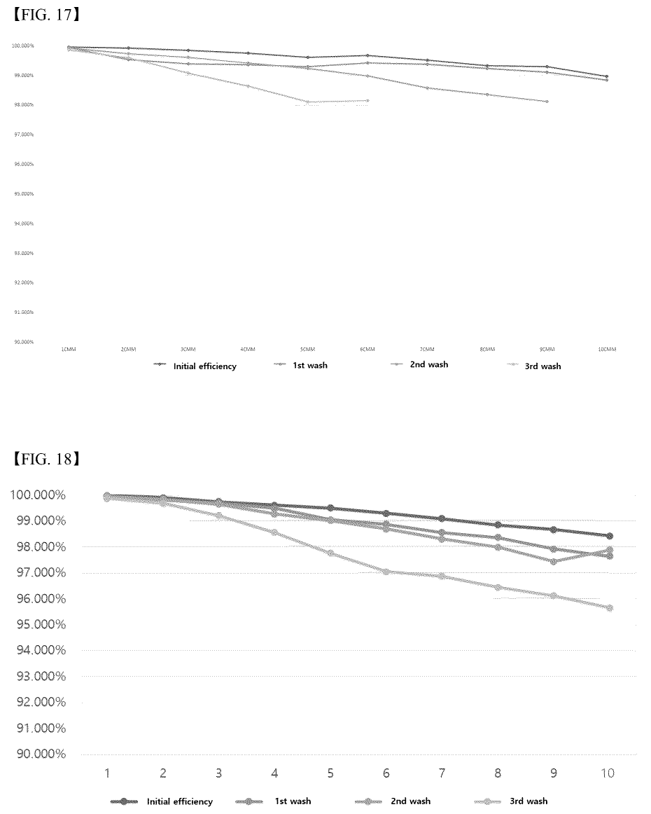

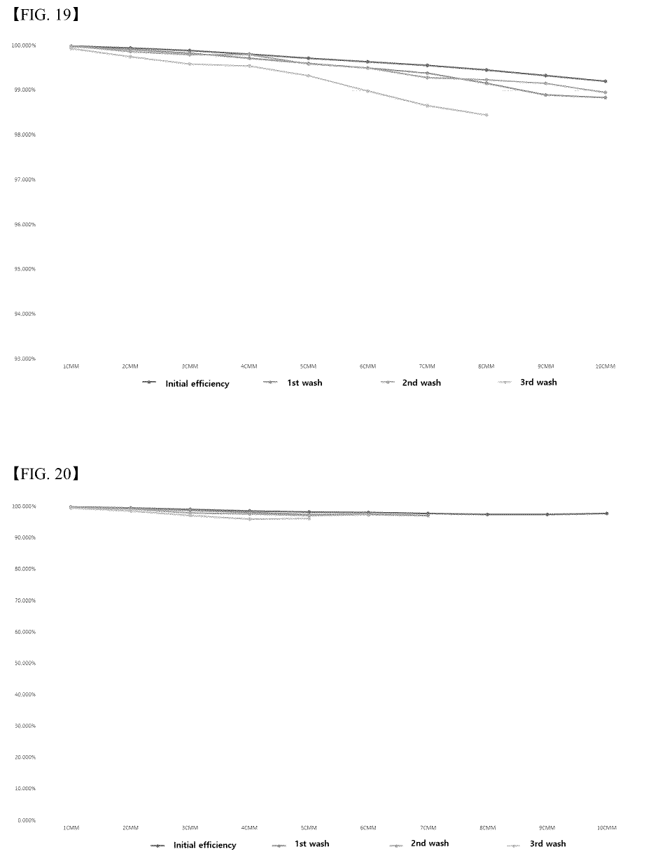

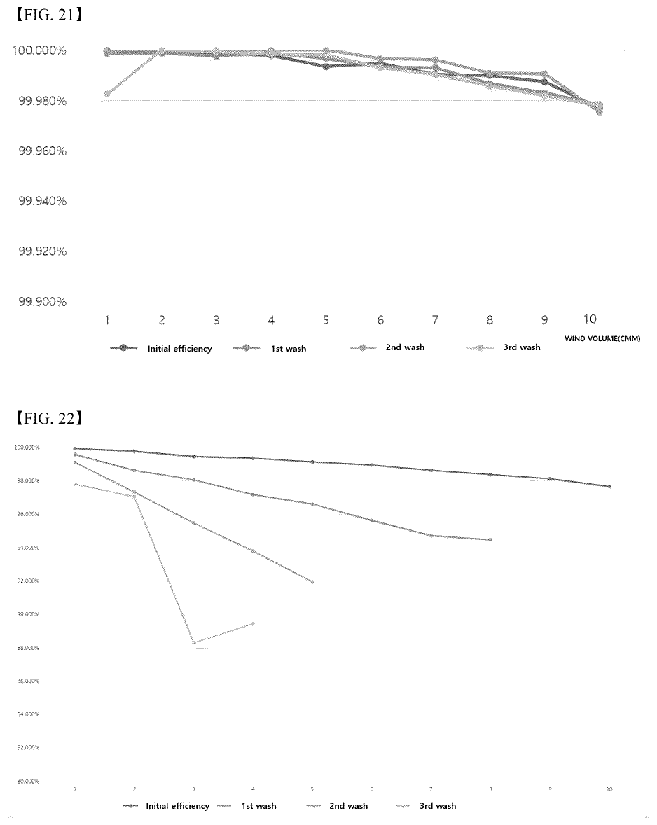

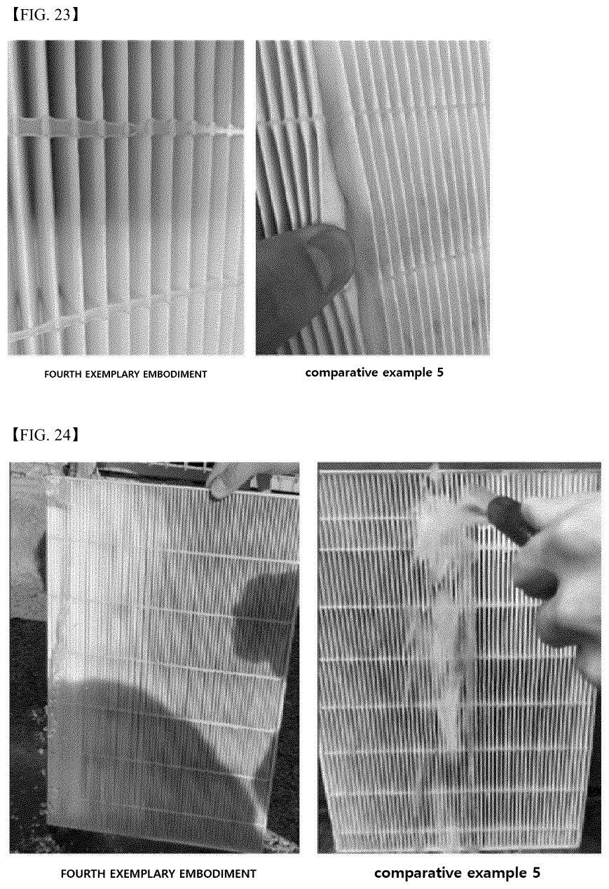

Filter performance according to cleaning of the filter modules prepared according to the first to sixth exemplary embodiments and the second comparative example was measured by changing the efficiency for each air volume in the wind turbine according to the KSB 6141 method. In the cleaning process, fine dust was artificially sprayed on the manufactured filter member to generate pollution, and then washed with water and sufficiently dried to measure the fine dust filter cleaning rate. The above process was repeated three times, and the results are shown in FIGS. 16 to 22, respectively.

Referring to results of the following FIGS. 16 to 23, in the case of filters including nano fiber layers using TPU nano fibers, PVDF nano fibers, and PTFE nano fibers, respectively, according to the first to sixth exemplary embodiments of the present invention, it can be confirmed that efficiency is maintained by 95% or more in all filters up to wind volume of 5 CMM or more even after washing three times.

However, as in the second comparative example, it was confirmed that the efficiency of the filter (FIG. 22) outside the range of the present invention was decreased to 90% or less at the air volume of 4 CMM.

### Fourth Experimental Example: Cleaning Efficiency Comparative Experiment Based on Hot-Melt Coating Method

In the filter module manufactured in accordance with the fourth exemplary embodiment and the fifth comparative example, the cleaning effect in accordance with the hot-melt coating method was measured while washing the filter module with water.

The following FIG. 23 illustrates a photograph of hot-melt coated filter member, in the present invention as shown in the fourth exemplary embodiment, the upper part of the filter member is coated with a constant gap (interval) of 53 mm and a thickness of 3.5 mm, whereas in the fifth comparative example, the entire upper part of the filter member is coated with a hot-melt coating with a thickness of 1.5 mm.

Furthermore, referring to FIG. 24, a photograph of experimenting the cleaning effect of fine dust attached to the filter member while washing each of the filter members with water, in the case of including a hot-melt coating layer as in the fourth exemplary embodiment of the present invention, it was confirmed that fine dust flows down along the water when washing with water. On the other hand, as in the fifth comparative example, when the hot-melt coating layer is included on the entire filter member, it can be seen that water bounces out, not removing fine dust together when washing with water.

From these results, when a nano fiber layer corresponding to the present invention is introduced into the filter member, a predetermined hot-melt coating layer is applied only to a part of the filter member, and the filter frame is water-repellent, it has been confirmed that fine dust can be easily removed through filtering, the remaining fine dust can be effectively washed by simply washing with water, and the filter efficiency can be maintained even after washing with water, so it can be repeatedly recycled.

### INDUSTRIAL APPLICABILITY

According to the present invention, the filter module manufactured using nano fibers may effectively maintain filter performance even after water washing, and thus may be repeatedly cleaned and regenerated, thereby having excellent industrial use.

1. A cleanable fine dust filter module using nano fibers, comprising:
a filter member 10 having a multilayer structure including a nano fiber layer using nano fibers where the multi-layered structure has a wrinkled shape spaced apart at regular intervals; and
a water-repellent filter frame 20 that accommodates the filter member 10.

2. The cleanable fine dust filter module of claim 1, wherein the nano fiber is any one selected from:
what was manufactured by electrospinning using polyvinylidene fluoride (PVDF) with an efficiency of 75-95% and a pressure loss of less than 10 mmAq, or by using thermoplastic polyurethane (TPU); and
a PTFE manufactured using an elongation method with an efficiency of 70-95% and a pressure loss of less than 5 mmAq.

3. The cleanable fine dust filter module of claim 1, wherein the multi-layered structure is any one structure selected from:
a melt blown (MB) electrostatic filter layer/PET support layer/nano fiber layer, PET support layer/MB electrostatic filter layer/nano fiber layer, MB electrostatic filter layer/PET support layer/first nano fiber layer/second nano fiber layer; and
an MB electrostatic filter layer/nano fiber layer/PET support layer MB.

4. The cleanable fine dust filter module of claim 1, wherein the filter member 10 includes a hot-melt coating layer 11 formed on the upper and lower parts of the filter member 10 for fixing a pitch gap of the filter module with a gap of 40˜70 mm and a thickness of 1˜5 mm in order to maintain a corrugated shape spaced apart from each other at regular intervals.

5. The cleanable fine dust filter module of claim 1, wherein removal of fine dust using the fine dust filter is implemented through:
a primary surface filtration process in which 80±10% of fine dust is removed while passing through the nano fiber layer; and
a secondary depth filtration process in which the remaining 20±10% of fine dust that cannot be removed from the nano fiber layer and that passes through the nano fiber layer is removed while passing through the MB electrostatic filter layer.

6. The cleanable fine dust filter module of claim 1, wherein the fine dust filter is used to remove fine dust (particular matter, PM-10) less than 10 μm, and the filter efficiency for the fine dust is 95% or more at a wind volume of 1-10 CMM.

7. The cleanable fine dust filter module of claim 1, wherein the filter module is water washable, and the filter efficiency for fine dust after water washing is more than 95% at the air volume of 5 CMM.
